(19) United States
(12) Patent Application Publication
(10) Pub. No.: US 2024/0158654 A1
(43) Pub. Date: May 16, 2024

(54) Aqueous Ink Jet Ink Composition And Ink Jet Recording Method

(71) Applicant: SEIKO EPSON CORPORATION, Tokyo (JP)

(72) Inventors: Miki UCHIDA, Matsumoto (JP); Yusuke MIZUTAKI, Shiojiri (JP); Yuko HISHIDA, Matsumoto (JP)

(21) Appl. No.: 18/497,011

(22) Filed: Oct. 30, 2023

(30) Foreign Application Priority Data
Oct. 31, 2022 (JP) 2022-174412

(51) Int. Cl. C09D 11/322; C09D 11/38

(52) U.S. Cl. CPC C09D 11/322; C09D 11/38

(57) ABSTRACT

An aqueous ink jet ink composition includes a coloring material, a water-soluble urethane resin, and an acetylene glycol-based surfactant having a HLB value of 6 or less. The content A of the acetylene glycol-based surfactant relative to the total mass of the ink jet ink composition is 0.1% by mass or more, and the ratio (A/U) of the content A of the acetylene glycol-based surfactant to the content U of the water-soluble urethane resin is from 0.3 to 2.3.

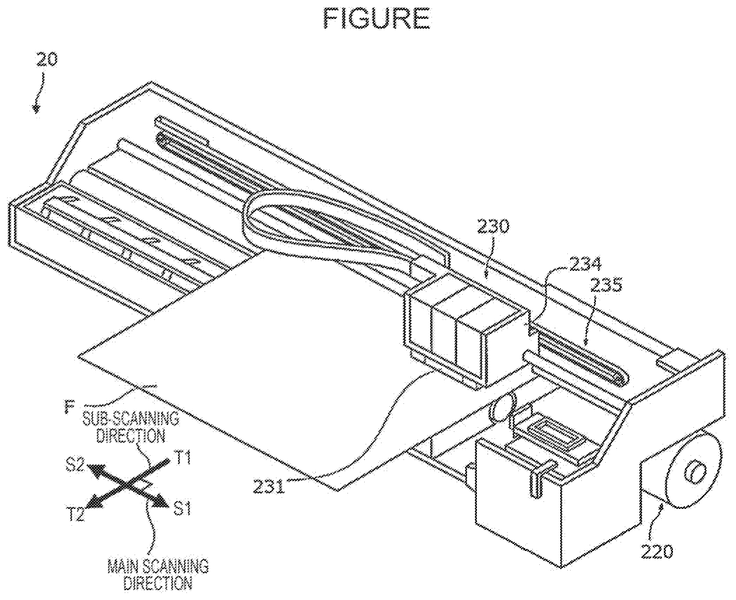

The present application is based on, and claims priority from JP Application Serial Number 2022-174412, filed Oct. 31, 2022, the disclosure of which is hereby incorporated by reference herein in its entirety.

### BACKGROUND

### 1. Technical Field

The present disclosure relates to an aqueous ink jet ink composition and an ink jet recording method.

### 2. Related Art

An ink jet recording method can record high-definition images by a relatively simple apparatus, and is rapidly developed in various fields. For example, JP-A-2002-146255 discloses, for the purpose of improving ejection stability of ink droplets and clogging reliability, an ink composition for ink jet recording, which contains at least a pigment, an acetylene glycol-based surfactant, triethylene glycol monobutyl ether, 2-pyrrolione, water, and a water-soluble organic solvent.

However, it was found that when an ink jet ink composition containing an acetylene glycol-based surfactant is dried in nozzles, a decrease in ejection reliability, such as flying curve or the like, easily occurs.

### SUMMARY

An ink jet ink composition according to an aspect of the present disclosure is an aqueous ink jet ink composition containing a coloring material, a water-soluble urethane resin, and an acetylene glycol-based surfactant having a HLB value of 6 or less. The content A of the acetylene glycol-based surfactant is 0.1% by mass or more relative to the total mass of the ink jet ink composition, and the ratio (A/U) of the content A of the acetylene glycol-based surfactant to the content U of the water-soluble urethane resin is from 0.3 to 2.3.

An ink jet recording method according to an aspect of the present disclosure is a recording method including an ink adhesion step of ejecting and adhering the ink jet ink composition from an ink jet head to a recording medium.

### BRIEF DESCRIPTION OF THE DRAWING

FIGURE is a drawing showing an example of a recording apparatus used in an embodiment of the present disclosure.

### DESCRIPTION OF EMBODIMENTS

An embodiment of the present disclosure (referred to as a “present disclosure” hereinafter) is described in detail below, but the present disclosure is not limited to the embodiment and various modification can be made within a range not deviating from the gist of the present disclosure.

### 1. Ink Jet Ink Composition

An aqueous ink jet ink composition (also simply referred to as an “ink composition” hereinafter) according to a present embodiment contains a coloring material, a water-soluble urethane resin, and an acetylene glycol-based surfactant having a HLB value of 6 or less. The content A of the acetylene glycol-based surfactant is 0.1% by mass or more relative to the total mass of the ink jet ink composition, and the ratio (A/U) of the content A of the acetylene glycol-based surfactant to the content U of the water-soluble urethane resin is from 0.3 to 2.3.

Even on an absorptive recording medium such as plain paper, an ink composition may temporarily remain on the recording medium depending on the permeability of the ink composition to the recording medium. When before permeated, such an ink composition adheres to a transport path such as a transport belt, a transport roller, or the like, another recording medium is stained. The adhesion of the ink composition may also decrease transportability of the recording medium. For example, the adhesion of the ink composition may change the surface state of the transport path and thus change the friction between the recording medium and the transport path, thereby decreasing transportability. Also, assuming that a portion of the transport path is an electrostatic attraction belt, the adhesion of the ink composition can decrease the attraction property of the recording medium due to a decrease in resistance value of the electrostatic attraction belt of the transport path, thereby decreasing transportability.

Thus, it is considered to use an acetylene glycol-based surfactant having a low HLB value for the purpose of improving permeability of the ink composition to the recording medium. This can suppress the transfer of the ink composition, which does not yet permeate, to another portion because of more improvement in permeability of the ink composition to the recording medium. However, it has been known that the use of the acetylene glycol-based surfactant having a low HLB value causes flying curve and scattering and thus decreases ejection reliability. In particular, when the ink jet head is allowed to stand without being capped or allowed to stand for a long period, the ejection reliability is easily decreased due to the progress of drying of the ink in the nozzles.

A conceivable cause of the decrease in ejection reliability is that the phase separation between the acetylene glycol-based surfactant and water causes due to the progress of drying of the ink. In particular, the acetylene glycol-based surfactant having a low HLB value has excellent permeability but has high hydrophobicity and low solubility in water, and thus the phase separation is considered to easily occur. However, the cause of the decrease in ejection reliability is not limited to this.

Therefor, in the present embodiment, the acetylene glycol-based surfactant having a low HLB value is used in combination with the water-soluble urethane resin at a predetermined ratio, and thus the decrease in ejection reliability is suppressed while improving permeability. A conceivable cause of the suppression of decrease in ejection reliability by the water-soluble urethane resin is that the acetylene glycol-based surfactant is absorbed or included by the water-soluble urethane resin when the ink composition is dried, thereby suppressing the occurrence of phase separation. However, the cause of the suppression of decrease in ejection reliability is not limited to this.

Further, depending on the type of the resin component, foreign substances may occur at a gas-liquid interface in which the ink composition contacts a gas, and thus an ejection defect may be caused. However, the water-soluble urethane resin hardly produces foreign substances at the gas-liquid interface.

Each of the components of the ink composition of the present embodiment is described in detail below.

### 1. 1. Coloring Material

Examples of the coloring material include, but are not particularly limited to, a dye, a pigment, and the like, and among these, a pigment is preferably used from the viewpoint of a wide range of usable recording media and the property of causing little discoloration with light, gas, and the like, etc.

Examples of the pigment include, but are not particularly limited to, organic pigments such as azo pigments (for example, an azo lake, an insoluble azo pigment, a condensed azo pigment, a chelate azo pigment, and the like), polycyclic pigments (for example, a phthalocyanine pigment, a perylene pigment, a perinone pigment, an anthraquinone pigment, a quinacridone pigment, a dioxazine pigment, a thioindigo pigment, an isoindolinone pigment, a quinophthalone pigment, and the like), a nitro pigment, a nitroso pigment, aniline black, and the like; inorganic pigments such as carbon black (for example, furnace black, thermal lamp black, acetylene black, channel black, and the like), metal oxides, metal sulfides, metal chlorides, and the like; extender pigments such as silica, calcium carbonate, talc, and the like; and the like. The pigments may be used alone or in combination of two or more.

Other examples of the pigment include, but are not particularly limited to, a resin-dispersed pigment dispersed by coating with a dispersant resin, a self-dispersing pigment dispersing without using a dispersant resin, and the like.

The resin-dispersed pigment is a pigment dispersed by a resin. The resin used for dispersing a pigment is also referred to as a “dispersant resin”. The dispersant resin represents a resin used for coating pigment surfaces for improving the water dispersibility of the pigment. The resin-dispersed pigment is a pigment including the dispersant resin adsorbed, adhered, or coated on the pigment. A water-soluble resin or a water-insoluble resin can be used as the dispersant resin. The resin-dispersed pigment can be prepared by a method of dispersing a pigment by stirring the dispersant resin and the pigment in water, a method of stirring the dispersant resin and the pigment in an organic solvent and then performing transfer emulsification with a water phase, or the like.

The self-dispersing pigment is a pigment having a functional group for improving water dispersibility of the pigment, which is introduced to the pigment surfaces directly or indirectly by chemical bonding. The functional group is a hydrophilic group and is preferably an acid group. Examples of the hydrophilic group include a carboxyl group, a sulfo group, phosphorus-containing groups such as a phosphate group, and the like, and the like.

The pigment preferably contains any one or more of the self-dispersing pigment and the resin-dispersed pigment. When the dispersant resin or another dispersant is used, the dispersants may be used alone or in combination of two or more.

In the present embodiment, the “dispersant resin” is a resin which disperses a pigment, and is also referred to as a “resin dispersant”. Therefore, in this respect, the dispersant resin is different from a resin of a dispersion resin, resin particles, a resin emulsion, or a resin for the purpose of fixing, which is not used as a dispersant for a pigment.

The content of the coloring material relative to the total amount of the ink composition is preferably from 1.0% to 14% by mass, from 2.0% to 12% by mass, from 4.0% to 10% by mass, or from 6.0% to 8.0% by mass.

### 1. 2. Acetylene Glycol-Based Surfactant

### 1. 2. 1. Acetylene Glycol-Based Surfactant Having HLB Value of 6 or Less

The permeability of the ink composition to a recording medium is more improved by containing the acetylene glycol-based surfactant having a HLB value of 6 or less, and the ink composition, which does not yet permeate, hardly remains. This can suppress the contamination of the transport path, the transfer of the contamination of the transport path to the recording medium, and a decrease in transportability.

The HLB value of the acetylene glycol-based surfactant is 6 or less and preferably 5 or less or 4 or less. With a HLB value of 6 or less, the permeability of the ink composition tends to be more improved. Also, the lower limit of the HLB value is 0 or more, 1 or more, or 2 or more. When the lower limit of the HLB value is within the range described above, there is a tendency that less phase separation occurs, and the ejection reliability is more improved. In addition, the HLB value is a value representing the balance between hydrophobicity and hydrophilicity of the surfactant, and a lower HLB value indicates higher hydrophobicity, and a higher HLB value indicates higher hydrophilicity. In the present disclosure, the HLB value is calculated by a Griffin method as described in a method of examples below.

Examples of the acetylene glycol-based surfactant having a HLB value of 6 or less include, but are not particularly limited to, acetylene glycol represented by formula (1) below and an acetylene glycol alkylene oxide adduct represented by formula (2) below. Among these, the acetylene glycol represented by the formula (1) is preferred. The use of such an acetylene glycol-based surfactant tends to more improve permeability.

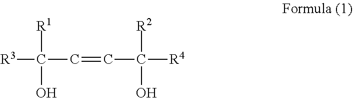

(In the formula (1), R¹ to R⁴ each independently represent an alkyl group having 1 to 4 carbon atoms.)

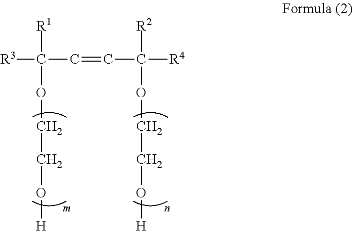

In the formula (2), R¹ to R ⁴ each independently represent an alkyl group having 1 to 4 carbon atoms, m and n each independently represent an integer of 0 or 1 or more, and n+m=1 to 30 is satisfied.

In addition, m is preferably from 1 to 15, from 1 to 10, or from 1 to 5, and n is preferably from 1 to 15, from 1 to 10, or from 1 to 5.

Examples of each of R¹ to R⁴ include, but are not particularly limited to, methyl ethyl, n-propyl, iso-propyl, n-butyl, sec-butyl, and tert-butyl.

Examples of the structure of the acetylene glycol-based surfactant having a HLB value of 6 or less include a compound represented by the formula (1) and a compound represented by the formula (2). In a compound represented by the formula (2), n and m are each preferably within or lower than the range described above, 15 or less, 9 or less, or 8 or less. Examples of the compound include, but are not particularly limited to, 2,4,7,9-tetramethyl-5-decyne-4,7-diol or an alkylene oxide adduct thereof, in which each of the numbers (n, m) of added moles of the adduct is within or lower than the range described above, that is, 15 or less, 9 or less, or 8 or less.

The content A of the acetylene glycol-based surfactant having a HLB value of 6 or less relative to the total amount of the ink composition is preferably 0.1% by mass or more, 0.2% by mass or more, or 0.25% by mass or more. When the content A of the acetylene glycol-based surfactant having a HLB value or 6 or less is 0.1% by mass or more, permeability tends to be improved, and transfer evaluation tends to become good. The content A of the acetylene glycol-based surfactant having a HLB value of 6 or less relative to the total amount of the ink composition is preferably 1.0% by mass or less, 0.8% by mass or less, 0.6% by mass or less, or 0.4% by mass or less. When the content A of the acetylene glycol-based surfactant having a HLB value of 6 or less is within the range described above, ejection reliability tends to be more improved.

The ratio (A/U) of the content A of the acetylene glycol-based surfactant to the content U of the water-soluble urethane resin described later is from 0.3 to 2.3, and preferably from 0.5 to 2.1, from 0.7 to 1.9, from 0.9 to 1.7, or from 1.0 to 1.5. With the ratio (A/U) of 0.3 or more, permeability tends to be more improved, and transfer tends to be more suppressed. With the ratio (A/U) of 2.3 or less, ejection stability tends to be more improved.

### 1. 2. 2. Acetylene Glycol-Based Surfactant Having HLB Value of More Than 6

The ink composition of the present embodiment may contain an acetylene glycol-based surfactant having a HLB value of more than 6. When the acetylene glycol-based surfactant having a HLB value of more than 6 is contained together with the acetylene glycol-based surfactant having a HLB value of 6 or less, permeability of the ink composition to the recording medium is more improved, and the ink composition, which does not yet permeates, hardly remains. This can suppress the contamination of the transport path with the ink composition which does not yet permeate, the transfer of the contamination of the transport path to another recording medium, and a decrease in transportability. Also, when the acetylene glycol-based surfactant having a HLB value of more than 6 is used in combination with the acetylene glycol-based surfactant having a HLB value of 6 or less, both the permeability and ejection reliability can be improved. In addition, the presence of the acetylene glycol-based surfactant having a large HLB value preferably improves the compatibility of the acetylene glycol-based surfactant having a small HLB value with water.

The HLB value of the acetylene glycol-based surfactant is more than 6 and preferably 7 or more, or 8 or more. When the lower limit of the HLB value is within the range described above, there is a tendency that less phase separation occurs, and ejection reliability is more improved. In addition, the upper limit of the HLB value is preferably 14 or less, 13 or less, or 12 or less. When the upper limit of the HLB value is within the range described above, the permeability of the ink composition tends to be more improved.

Examples of a specific structure of the acetylene glycol-based surfactant having a HLB value of more than 6 include, but are not particularly limited to, 5,8-dimethyl-6-decyne-5,8-diol or alkylene oxide adducts thereof, 4,7-dimethyl-5-decyne-4,7-diol or alkylene oxide adducts thereof, and alkylene oxide adducts of 2,4,7,9-tetramethyl-5-decyne-4,7-diol, in which any one or each of the numbers of added moles of an adduct is 9 or more, 10 or more, or 16 or more. Other examples include a compound represented by the formula (2) in which any one or each of the numbers (n, m) of added moles of the adduct is 9 or more, 10 or more, or 16 or more.

The content of the acetylene glycol-based surfactant having a HLB value of more than 6 relative to the total amount of the ink composition is preferably 1% by mass or less, 0.8% by mass or less, or 0.5% by mass or less. When the content of the acetylene glycol-based surfactant having a HLB value of more than 6 is within the range described above, there is a tendency that permeability is improved, and the transfer evaluation becomes good. The content of the acetylene glycol-based surfactant having a HLB value of more than 6 relative to the total amount of the ink composition is preferably 0.1% by mass or more, 0.2% by mass or more, or 0.3% by mass or more. When the content of the acetylene glycol-based surfactant having a HLB value of more than 6 is within the range described above, ejection reliability tends to be more improved.

The total content of the acetylene glycol-based surfactant having a HLB value 6 or less and the acetylene glycol-based surfactant having a HLB value of more than 6 relative to the total amount of the ink composition is 0.1% by mass or more, and preferably from 0.1% to 2.0% by mass, from 0.4% to 1.0% by mass, or from 0.5% to 0.8% by mass.

### 1. 3. Water-Soluble Urethane Resin

The water-soluble urethane resin represents a water-soluble urethane resin having a polar group in the structure thereof. The polar group may be in a salt state. Also, the polar group is preferably an acid group. Examples of the acid group include a carboxyl group, a sulfonate group, a phosphorus-containing group such as a phosphate group or the like, and the like. In the present disclosure, the “water-soluble resin” represents a resin which is dissolved in water or an aqueous medium as a mixed solvent of water and a water-soluble organic solvent, in particular, dissolved in water, and which can be present in water or an aqueous medium in a state not having a particle diameter measured by a dynamic light-scattering method.

As described above, the acetylene glycol-based surfactant having a HLB value of 6 or less improves permeability, but has low solubility in water or the like. Therefore, when drying of the ink composition is progressed, there is a tendency that phase-separation from water occurs, and ejection reliability is decreased. However, when such an acetylene glycol-based surfactant is used in combination with the water-soluble urethane resin, there is a tendency that the phase separation is suppressed, and the ejection reliability is improved.

The water-soluble urethane resin has a repeating unit derived from polyisocyanate and polyol, and is preferably a resin having a repeating unit derived from polyol having an acid group. Further, preferred is a resin having a repeating unit derived from each of polyisocyanate, polyol not having an acid group, and polyol having an acid group. The water-soluble urethane resin may further have a repeating unit derived from polyamine.

The “polyisocyanate” represents a compound having two or more isocyanate groups in its molecular structure, and examples thereof include, but are not particularly limited to, aliphatic polyisocyanate, aromatic polyisocyanate, and the like.

Examples of the aliphatic polyisocyanate include, but are not particularly limited to, polyisocyanates having a chain structure, such as tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, 3-methylpentane-1,5-diisocyanate, and the like; polyisocyanates having a cyclic structure, such as isophorone diisocyanate, hydrogenated xylylene diisocyanate, 4,4′-dicyclohexylmethane diisocyanate, 1,4-cyclohexane diisocyanate, methylcyclohexylene diisocyanate, 1,3-bis(isocyanatomethyl)cyclohexane, and the like; and the like.

Examples of the aromatic polyisocyanate include, but are not particularly limited to, tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, dialkyl diphenylmethane diisocyanate, tetraalkyl diphenylmethane diisocyanate, α,α,α′,α′-tetramethylxylylene diisocyanate, and the like.

The polyol is a compound having two or more hydroxyl groups in its molecular structure. Examples of the polyol of the present embodiment include, but are not particularly limited to, polyol not having an acid group, and polyol having an acid group.

Examples of the polyol not having an acid group include, but are not particularly limited to, polyether polyol, polyester polyol, polycarbonate polyol, and the like.

Examples of the polyether polyol include, but are not particularly limited to, addition polymers of alkylene oxide and polyols, glycols, and the like.

Examples of the alkylene oxide include, but are not particularly limited to, ethylene oxide, propylene oxide, butylene oxide, a-olefin oxide, and the like. Examples of the polyols, which are addition-polymerized with alkylene oxide, include diols such as 1,3-propanediol, 1,3-butanediol, 1,4-butanediol, 1,5-pentanediol, 1,6-hexanediol, 3-methyl-1,5-pentanediol, 2-butyl-2-ethyl-1,3-propanediol, 1,4-cyclohexanediol, 1,4-cyclohexanedimethanol, 4,4-dihycroyphenylpropane, 4,4-dihydroxyphenylmethane, hydrogenated bisphenol A, dimethylol urea, and derivatives thereof, and the like; glycerin, trimethylolpropane, 1,2,5-hexanetriol, 1,2,6-hexanetriol, pentaerythritol, trimethylol melamine, and derivatives thereof; triol such as polyoxypropylenetriol and the like; and the like.

Examples of the glycols include (poly)alkylene glycols such as tetramethylene glycol, hexamethylene glycol, ethylene glycol, diethylene glycol, triethylene glycol, tetraethylene glycol, polyethylene glycol, propylene glycol, dipropylene glycol, tripropylene glycol, polypropylene glycol, (poly)tetramethylene glycol, and the like; a copolymer of ethylene glycol and propylene glycol; and the like.

The polyester polyol is not particularly limited but is, for example, an acid ester or the like. Examples of an acid component constituting an acid ester include, but are not particularly limited to, aromatic dicarboxylic acids such as phthalic acid, naphthalene dicarboxylic acid, biphenyl dicarboxylic acid, tetrahydrophthalic acid, and the like; alicyclic dicarboxylic acids such as hydrogenated products of these aromatic dicarboxylic acids; aliphatic dicarboxylic acids such as malonic acid, succinic acid, tartaric acid, oxalic acid, glutaric acid, adipic acid, pimelic acid, suberic acid, azelaic acid, sebacic acid, alkylsuccinic acid, linoleic acid, maleic acid, fumaric acid, mesaconic acid, citraconic acid, itaconic acid, and the like; and the like. Also, acid anhydrides, salts, derivatives (alkyl esters and acid halides), and the like of these acids can be used. In addition, examples of a component which forms an ester with the acid component include, but are not particularly limited to, polyols such as diol, triol, and the like; glycols such as (poly)alkylene glycol and the like; and the like. Examples of the polyols and glycols include the same examples as those of the component constituting the polyether polyol.

The polycarbonate polyol is not particularly limited, but, for example, polycarbonate polyol produced by a known method can be used. Specific examples thereof include alkanediol-based polycarbonate diols such as polyhexamethylene carbonate diol and the like. Other examples include polycarbonate diol produced by reacting a carbonate component, such as alkylene carbonate, diaryl carbonate, dialkyl carbonate, or the like and phosgene with an aliphatic diol component, and the like.

Examples of the polyol having an acid group include, but are not particularly limited to, polyol having an acid group such as a carboxylate group, a sulfonate group, a phosphate group, a phosphonate group, or the like, and the like. Among these, any one or more of a carboxyl group, a sulfonate group, and a phosphorus-containing group such as a phosphate group or the like, are preferred, and a carboxyl group is more preferred.

Examples of a polyol having a carboxylate group include, but are not particularly limited to, dimethylol acetic acid, dimethylol propionic acid, dimethylol butanoic acid, dimethylol butyric acid, and the like.

The acid group of the polyol having an acid group may be in a salt state. Examples of a cation which forms such a salt include, but are not particularly limited to, alkali metal ions, organic amine cations, and the like. Examples of alkali metal ions include, but are not particularly limited to, lithium, sodium, potassium, and the like. Examples of organic amine cations include, but are not particularly limited to, ammonium ion, dimethylamine, and the like.

Examples of polyamine include, but are not particularly limited to, monoamines having a plurality of hydroxyl groups, such as dimethylol ethylamine, diethanol methylamine, dipropanol ethylamine, dibutanol methylamine, and the like; difunctional polyamines such as ethylene diamine, propylene diamine, hexylene diamine, isophorone diamine, xylylene diamine, diphenylmethane diamine, hydrogenated diphenylmethane diamine, hydrazine, and the like; tri- or higher-functional polyamines such as diethylene triamine, triethylene tetramine, tetraethylene pentamine, polyamide polyamine, polyethylene polyimine, and the like; and the like.

The acid value of the water-soluble urethane resin is preferably from 40 to 90 mgKOH/g, from 45 to 80 mgKOH/g, or from 50 to 70 mgKOH/g. The acid value of the water-soluble urethane resin is not particularly limited, but can be adjusted by, for example, the use amount of polyol having an acid group. In addition, a method described in examples below can be used as a method for measuring the acid value.

The weight-average molecular weight Mw of the water-soluble urethane resin is preferably from 5000 to 150000, from 10000 to 100000, from 15000 to 50000, from 20000 to 30000, or from 20000 to 23000. The weight-average molecular weight Mw of the water-soluble urethane resin is not particularly limited, but can be adjusted by, for example, the temperature, time, etc. of reaction of polyisocyanate and polyol. In addition, a method described in examples below can be used as a method for measuring the weight-average molecular weight Mw.

The number-average molecular weight Mn of the water-soluble urethane resin is preferably from 2000 to 7000 or from 3500 to 5000. The number-average molecular weight Mn of the water-soluble urethane resin is not particularly limited, but can be adjusted by, for example, the temperature, time, etc. of reaction of polyisocyanate and polyol. In addition, a method described in examples below can be used as a method for measuring the number-average molecular weight Mn.

The content U of the water-soluble urethane resin relative to the total amount of the ink composition is preferably from 0.05% to 0.9% by mass, from 0.1% to 0.8% by mass, or from 0.2% to 0.7% by mass. When the content U of the water-soluble urethane resin is within the range described above, ejection reliability tends to be more improved.

### 1. 4. Dispersion Resin

The ink composition of the present embodiment may or may not contain a dispersion resin. The dispersion resin is a resin for improving fixability of the ink composition to the recording medium, and is distinguished from a resin dispersant. The dispersion resin may be in a dispersion form, a particle form, or an emulsion form.

Examples of the dispersion resin include, but are not particularly limited to, resin particles composed of a urethane-based resin, an acrylic resin, a fluorene-based resin, a polyolefin-based resin, a rosin-modified resin, a terpene-based resin, a polyester-based resin, a polyamide-based resin, an epoxy-based resin, a vinyl chloride-based resin, an ethylene-vinyl aetate-based resin, or the like. The dispersion resins may be used alone or in combination of two or more.

The urethane-based resin is a generic name of resins having a urethane bond, and examples thereof include, but are not particularly limited to, a polyether-type urethane resin having an ether bond in its main chain, a polyester-type urethane resin having an ester bond in its main chain, and a polycarbonate-type urethane resin having a carbonate bond in its main chain. The urethane-based resin may be a prepared product prepared by a known method, and a commercial product may be used.

The acrylic resin is a generic name of polymers produced by polymerizing at least an acrylic monomer as a component, such as a (meth)acrylic acid, a (meth)acrylate ester, or the like. Examples of the acrylic resin include, but are not particularly limited to, a polymer of a (meth)acrylic monomer such as (meth)acrylic acid, (meth)acrylate ester, or the like, a copolymer of a (meth)acrylic monomer and another monomer, such as a styrene-acrylic resin or the like. The acrylic resin may be a prepared product prepared by a known method, and a commercial product may be used.

When the dispersion resin is contained or not contained, the content of the dispersion resin relative to the total amount of the ink composition is preferably 0.4% by mass or less, 0.2% by mass or less, less than 0.2% by mass, 0.15% by mass or less, or 0.1% by mass or less. The ink composition may not contain the dispersion resin in particular. When the content of the dispersion resin is 0.4% by mass or less, the occurrence of foreign substances at the gas-liquid interface tends to be more suppressed.

Examples of a place where the gas-liquid interface is produced in a recording apparatus include, but are not limited to, a member in which an air layer and an ink layer are formed, such as a non-pack type ink container or sub-tank, or the like. Besides the ink container, a gas-liquid interface may be produced in a filter, a valve, or the like, which is disposed in the ink flow path from the ink container to an ink jet head.

### 1. 5. Inorganic Oxide Particles

The ink composition of the present embodiment preferably contains inorganic oxide particles. The term “inorganic oxide particles” represents fine particles of an inorganic oxide in a state of being dispersed in a dispersion medium.

When the ink composition contains the inorganic oxide particles, curling resistance and color development tend to be excellent.

Examples of the inorganic oxide particles include, but are not particularly limited to, metal oxides such as silica, alumina, titania, zirconia, antinomy oxide, tin oxide, tantalum oxide, zinc oxide, cerium oxide, lead oxide, indium oxide, and the like; metal nitrides such as silicon nitride, titanium nitride, aluminum nitride, and the like; metal carbides such as silicon carbide, titanium carbide, and the like; metal sulfides such as zinc sulfide and the like; metal carbonate salts such as calcium carbonate, magnesium carbonate, and the like; metal sulfate salts such as calcium sulfate, magnesium sulfate, and the like; metal silicate salts such as calcium silicate, magnesium silicate, and the like; metal phosphate salts such as calcium phosphate and the like; metal borate salts such as aluminum borate, magnesium borate, and the like; composite compounds thereof; and the like. The inorganic oxide particles may form a salt. These types of inorganic oxide particles may be used alone or in combination of two or more.

In particular, from the viewpoint of improving the curling resistance and color development, at least one or more of silica, alumina, titania, and zirconia are preferably contained, and silica is more preferably contained.

The average particle diameter of the inorganic oxide particles is preferably 100 nm or less, from 20 to 100 nm, from 30 to 80 nm, or from 40 to 60 nm. When the average particle diameter of the inorganic oxide particles is within the range described above, curling resistance, color development, and ejection reliability tend to be excellent.

The average particle diameter of the inorganic oxide particles can be measured by a particle size distribution measurement apparatus using a dynamic light scattering method as a measurement principle. The particle size distribution measurement apparatus is not particularly limited but is, for example, “Zeta potential-particle size-molecular weight measurement system ELSZ2000ZS” (trade name) manufactured by Otsuka Electronics Co., Ltd., using a homodyne optical system as a frequency analysis method. The “average particle diameter” represents a number-based average particle diameter.

The content of the inorganic oxide particles in terms of solid content mass relative to the total amount of the ink composition is preferably from 0.1% to 8.0% by mass, from 0.5% to 6.0% by mass, from 1.0% to 5.0% by mass, or from 2.0% to 4.0% by mass. When the content of the inorganic oxide particles is within the range described above, the curling resistance and color development tend to be improved.

### 1. 6. Organic Solvent

The ink composition of the present embodiment may contain an organic solvent. Examples of the organic solvent include, but are not particularly limited to, monohydric alcohols, polyols, glycol ethers, and the like. Among these, polyols are more preferably contained, and polyols having a standard boiling point of over 280° C. are more preferably contained. Thus, the ejection reliability tends to be more improved. The organic solvents may be used alone or in combination of two or more.

Examples of the monohydric alcohols include, but are not particularly limited to, methanol, ethanol, 1-propnanol, isopropanol, 1-butanol, 2-butanol, isobutanol, 2-methyl-2-propanol, and the like.

Examples of polyols include, but are not particularly limited to, ethylene glycol, diethylene glycol, triethylene glycol, tetraethylene glycol, pentaethylene glycol, propylene glycol, dipropylene glycol, tripropylene glycol, 1,3-propanediol, 1,2-butandiol, 1,2-pentanediol, 1,2-hexanediol, 1,4-butanediol, 1,5-pentanediol, 1,6-hexanediol, glycerin, and the like.

Examples of the glycol ethers include, but are not particularly limited to, triethylene glycol monomethyl ether, triethylene glycol dimethyl ether, triethylene glycol monobutyl ether, diethylene glycol monobutyl ether, dipropylene glycol monopropyl ether, and the like.

Examples of polyols having a standard boiling point of over 280° C., among polyols, include, but are not particularly limited to, triethylene glycol, tetraethylene glycol, glycerin, and the like.

Examples of polyols having a standard boiling point of 280° C. or less include, but are not particularly limited to, ethylene glycol, diethylene glycol, pentaethylene glycol, propylene glycol, dipropylene glycol, tripropylene glycol, 1,3-propanediol, 1,2-butandiol, 1,2-pentanediol, 1,2-hexanediol, 1,4-butanediol, 1,5-pentanediol, 1,6-hexanediol, and the like.

The content of the organic solvent relative to the total amount of the ink composition is preferably from 5% to 35% by mass, from 8% to 30% by mass, from 10% to 26% by mass, from 12% to 22% by mass, or from 14% to 18% by mass.

The content of the polyols having a standard boiling point of over 280° C. relative to the total amount of the ink composition is preferably from 7% to 19% by mass, from 9% to 17% by mass, or from 11% to 15% by mass. When the content of the polyols having a standard boiling point of over 280° C. is within the range described above, the ejection reliability tends to be more improved.

### 1. 7. Water

Examples of the water contained in the ink composition of the present embodiment include, but are not particularly limited to, ion exchange water, ultrafiltered water, reverse osmosis water, distilled water, and the like. The ink of the present embodiment is an aqueous ink composition, and the aqueous ink composition is an ink composition containing water as at least a main solvent component of the ink.

The content of water relative to the total amount of the ink composition is preferably from 65% to 85% by mass, from 67.5% to 82.5% by mass, from 70% to 80% by mass, or from 72.5% to 77.5% by mass.

### 1. 8. Other Components

The ink composition of the present embodiment may contain, other than the components described above, other known components which are used in a general ink composition. Examples of the other components include, but are not particularly limited to, a solubilizer, a viscosity modifier, a pH adjuster, an antioxidant, a preservative, an anti-corrosive agent, a chelating agent for capturing predetermined metal ions, which influence dispersion, and other additives, an organic solvent other than the above, and the like. The other components may be used alone or in combination of two or more.

### 2. Recording Medium

Examples of a recording medium used for recording the ink composition of the present embodiment include, but are not particularly limited to, an absorptive recording medium, a low-absorptive recording medium, and a non-absorptive recording medium. The ink composition of the present embodiment is preferably used for recording on an absorptive recording medium among these.

Examples of the absorptive recording medium include, but are not particularly limited to, plain paper such as electrophotographic paper having high ink permeability, and the like; and ink jet paper (ink jet exclusive paper having an ink absorption layer including silica particles or alumina particles, or an ink absorption layer including a hydrophilic polymer such as polyvinyl alcohol (PVA), polyvinylpyrrolidone (PVP), or the like). A fabric may also be used.

Examples of the low-absorptive recording medium include, but are not particularly limited to, art paper, coated paper, cast paper, and the like, which have relatively low ink permeability and are used for general offset printing.

Examples of the non-absorptive recording medium include, but are not particularly limited to, films and plates of plastics such as polyvinyl chloride, polyethylene, polypropylene, polyethylene terephthalate (PET), polycarbonate, polystyrene, polyurethane, and the like; plates of metals such as iron, silver, copper, aluminum, and the like; metal plates produced by vapor deposition of various metals, plastic films, and plates of alloys such as stainless, brass, and the like; a recording medium including a paper-made substrate and a film bonded (coated) thereon, using plastic such as polyvinyl chloride, polyethylene, polypropylene, polyethylene terephthalate (PET), polycarbonate, polystyrene, polyurethane, or the like; and the like.

### 3. Ink Jet Recording Method

An ink jet recording method of the present embodiment includes an ink adhesion step of ejecting and adhering the ink jet ink composition of the present embodiment from an ink jet head to a recording medium, and the method may include, before the ink adhesion step, a supply step of supplying the ink jet ink composition to the ink jet head from an ink container through an ink flow path.

### 3. 1. Supply Step

In the supply step, the ink composition of the present embodiment is supplied to the ink jet head from the ink container through the ink flow path. In the supply step, a gas-liquid interface may occur in the ink composition, but the ink composition of the present embodiment contains the water-soluble urethane resin and thus tends to hardly produce the problem of filter clogging or the like caused by the occurrence of foreign substances at the gas-liquid interface.

In a printer, the gas-liquid interface may occur in a place where the ink composition is present. For example, the gas-liquid interface may occur in the ink container, a sub-tank, or the like. Also, a micro gas-liquid interface occurs in a filter, a valve, or the like.

### 3. 2. Ink Adhesion Step

In the ink adhesion step, the ink composition of the present embodiment is ejected and adhered from an ink jet head to a recording medium. More specifically, the ink composition filled in a pressure generating chamber of the ink jet head is ejected from nozzles by driving a pressure generating unit provided in the ink jet head.

The ink jet head used in the ink adhesion step is, for example, a line head which performs recording in a line system, and a serial head which performs recording in a serial system.

In the line system using the line head, for example, the ink jet head having a width equal to or larger than the recording width of the recording medium is fixed to a recording apparatus. Then, the recording medium is moved along the sub-scanning direction (transport direction of the recording medium), and ink droplets are ejected from the nozzles of the ink jet head in conjunction with the movement, thereby recording an image on the recording medium.

In the serial system using the serial head, for example, the ink jet head is mounted on a carriage which can be moved in the width direction of the recording medium. Then, the carriage is moved along the main scanning direction (width direction of the recording medium), and ink droplets are ejected from the nozzles of the ink jet head in conjunction with the movement, thereby recording an image on the recording medium.

### 4. Recording Apparatus

FIGURE is a perspective view showing a serial printer as an example of an ink jet apparatus. As shown in FIGURE, a serial printer 20 includes a transport portion 220 and a recording portion 230. In the transport portion 220, the recording medium F fed to the serial printer is transported to the recording portion 230, and the recording medium F after recording is discharged to the outside of the serial printer. Specifically, the transport portion 220 has feed rollers so as to transport the sent recording medium F in the sub-scanning direction T2.

In addition, the recording portion 230 is provided with a carriage 234 mounted with an ink jet head 231 having nozzles which eject the ink composition to the recording medium F sent from the transport portion 220, and a carriage moving mechanism 235 which moves the carriage 234 in the main scanning direction S1/S2 of the recording medium F.

The serial printer is provided with, as the ink jet head 231, a head having a length smaller than the width of the recording medium, and the head is moved to perform recording in a plurality of passes. Also, the serial printer includes the head 231 mounted on the carriage 234 which is moved in the predetermined direction, and the head is moved in association with the movement of the carriage, thereby ejecting the ink composition to the recording medium F. Therefore, recording is performed in 2 or more passes.

The pass is also referred to as “main scanning”. In addition, sub-scanning is performed between the passes to transport the recording medium. That is, main scanning and sub-scanning are alternately performed.

The ink jet apparatus of the present embodiment is not limited to the serial-system printer described above, and may be the line-system printer described above. The line-system printer is a printer which performs recording on the recording medium by one time of scanning using the line head serves as the ink jet head having a length equal to or longer than the recording width of the recording medium.

When the ink jet apparatus of the embodiment has a high recording speed (a large number of recording media recorded per unit time), the number of recording media stacked after recording is increased, and there is no time for the ink to permeate into the recording medium. Thus, in particular, the recording medium tends to be stained. Even in this case, the ink of the embodiment is particularly useful in view of enabling to decrease the stain of the recording medium. An ink jet apparatus having a high recording speed is, for example, a line-system printer or the like.

### EXAMPLES

The present disclosure is described in further detail below by using examples and comparative examples. The present disclosure is not limited to examples below.

### 1. Preparation of Ink Jet Ink Composition

Components were added to a tank for a mixture so as to obtain compositions described in Tables 1 and 2, mixed and stirred, and further filtered with a membrane filter, preparing ink jet ink compositions of examples and comparative examples. In addition, a numerical value of each of the components described in each of the examples of the tables represents “% by mass” unless otherwise specified. Also, in Tables 1 and 2, the content (% by mass) of each of the coloring material, dispersion resin, water-soluble resin, and inorganic oxide particles represents “solid content concentration”.

TABLE 1

| | | | HLB | Example | | | | | |
|---|---|---|---|---|---|---|---|---|---|
| Item | | | value | 1 | 2 | 3 | 4 | 5 | 6 |
| Ink | Coloring material | Pigment | — | 7.000% | 7.000% | 7.000% | 7.000% | 7.000% | 7.000% |
| composition | Dispersion resin | Dispersion resin 1 | — | | | | | | |
| | | Dispersion resin 2 | — | | | | | | |
| | Water-soluble | Water-soluble urethane resin 1 | — | 0.200% | 0.200% | 0.200% | 0.200% | 0.200% | 0.500% |
| | resin | Water-soluble urethane resin 2 | — | | | | | | |
| | | Water-soluble acrylic resin | — | | | | | | |
| | Inorgaanic oxide | Cataloid SI-45P | — | | | | | | |
| | particle | | | | | | | | |
| | Acetylene glycol- | Olfine E1010 | 11 | 0.400% | 0.400% | 0.400% | 0.400% | 0.400% | 0.400% |
| | based surfactant | Surfynol 104PG50 | 4 | 0.100% | 0.200% | 0.250% | 0.300% | 0.400% | 0.250% |
| | | Surfynol 420 | 4 | | | | | | |
| | Organic solvent | Glycerin | — | 10.00% | 10.00% | 10.00% | 10.00% | 10.00% | 10.00% |
| | | TEG | — | 3.000% | 3.000% | 3.000% | 3.000% | 3.000% | 3.000% |
| | | TEGmBE | — | 1.000% | 1.000% | 1.000% | 1.000% | 1.000% | 1.000% |
| | | TEGmME | — | 2.000% | 2.000% | 2.000% | 2.000% | 2.000% | 2.000% |
| | Water | — | — | 76.300% | 76.200% | 76.150% | 76.100% | 76.000% | 75.850% |

| | | | | | | | | |
|---|---|---|---|---|---|---|---|---|
| Formula | Ratio (A) of low-HLB surfactant relative to water- | — | 0.50 | 1.00 | 1.25 | 1.50 | 2.00 | 0.50 |
| | soluble resin | | | | | | | |
| Results | Evaluation of foreign substance at gas-liquid | | A | A | A | A | A | A |
| | interface | | | | | | | |
| | Transfer evaluation (evaluation of belt resistance | | C | B | A | A | A | C |
| | value) | | | | | | | |
| | Transfer evaluation (evaluation of contact angle) | | C | B | A | A | A | C |
| | Evaluation of ejection reliability (evaluation of | | A | A | A | B | C | A |
| | scattering) | | | | | | | |
| | Evaluation of curling resistance | | B | B | B | B | B | B |
| | Evaluation of color development | | B | B | B | B | B | B |

| | | | Example | | | | | |
|---|---|---|---|---|---|---|---|---|
| Item | | | 7 | 8 | 9 | 10 | 11 | 12 |
| Ink | Coloring material | Pigment | 7.000% | 7.000% | 7.000% | 7.000% | 7.000% | 7.000% |
| composition | Dispersion resin | Dispersion resin 1 | | | | | | |
| | | Dispersion resin 2 | | | | | | |
| | Water-soluble | Water-soluble urethane resin 1 | 0.125% | 0.100% | 0.480% | | 0.200% | 0.200% |
| | resin | Water-soluble urethane resin 2 | | | | 0.200% | | |
| | | Water-soluble acrylic resin | | | | | | |
| | Inorgaanic oxide | Cataloid SI-45P | | | | | | 3.000% |
| | particle | | | | | | | |
| | Acetylene glycol- | Olfine E1010 | 0.400% | 0.400% | 0.400% | 0.400% | 0.400% | 0.400% |
| | based surfactant | Surfynol 104PG50 | 0.250% | 0.125% | 0.600% | 0.250% | | 0.250% |
| | | Surfynol 420 | | | | | 0.250% | |
| | Organic solvent | Glycerin | 10.00% | 10.00% | 10.00% | 10.00% | 10.00% | 10.00% |
| | | TEG | 3.000% | 3.000% | 3.000% | 3.000% | 3.000% | 3.000% |
| | | TEGmBE | 1.000% | 1.000% | 1.000% | 1.000% | 1.000% | 1.000% |
| | | TEGmME | 2.000% | 2.000% | 2.000% | 2.000% | 2.000% | 2.000% |
| | Water | — | 76.225% | 76.375% | 75.520% | 76.150% | 76.150% | 73.150% |

| | | | | | | | |
|---|---|---|---|---|---|---|---|
| Formula | Ratio (A) of low-HLB surfactant relative to water- | 2.00 | 1.25 | 1.25 | 1.25 | 1.25 | 1.25 |
| | soluble resin | | | | | | |
| Results | Evaluation of foreign substance at gas-liquid | A | A | A | A | A | B |
| | interface | | | | | | |
| | Transfer evaluation (evaluation of belt resistance | A | A | A | A | B | A |
| | value) | | | | | | |
| | Transfer evaluation (evaluation of contact angle) | A | A | A | A | A | A |
| | Evaluation of ejection reliability (evaluation of | C | A | A | B | B | A |
| | scattering) | | | | | | |
| | Evaluation of curling resistance | B | B | B | B | B | A |
| | Evaluation of color development | B | B | B | B | B | A |

TABLE 2

| | | | HLB | Comparative Example | | | | |
|---|---|---|---|---|---|---|---|---|
| Item | | | value | 1 | 2 | 3 | 4 | 5 |
| Ink | Coloring material | Pigment | — | 7.000% | 7.000% | 7.000% | 7.000% | 7.000% |
| composition | Dispersion resin | Dispersion resin 1 | — | | | | | |
| | | Dispersion resin 2 | — | | | | | |
| | Water-soluble | Water-soluble urethane resin 1 | — | 0.050% | 1.000% | 0.100% | 0.200% | |
| | resin | Water-soluble urethane resin 2 | — | | | | | |
| | | Water-soluble acrylic resin | — | | | | | 0.200% |
| | Inorgaanic oxide | Cataloid SI-45P | — | | | | | |
| | particle | | | | | | | |
| | Acetylene glycol- | Olfine E1010 | 11 | 0.400% | 0.400% | 0.400% | 0.400% | 0.400% |
| | based surfactant | Surfynol 104PG50 | 4 | 0.050% | 0.250% | 0.250% | 0.500% | 0.250% |
| | | Surfynol 420 | 4 | | | | | |
| | Organic solvent | Glycerin | — | 10.00% | 10.00% | 10.00% | 10.00% | 10.00% |
| | | TEG | — | 3.000% | 3.000% | 3.000% | 3.000% | 3.000% |
| | | TEGmBE | — | 1.000% | 1.000% | 1.000% | 1.000% | 1.000% |
| | | TEGmME | — | 2.000% | 2.000% | 2.000% | 2.000% | 2.000% |
| | Water | — | — | 76.500% | 75.350% | 76.250% | 75.900% | 76.150% |

| | | | | | | | |
|---|---|---|---|---|---|---|---|
| Formula | Ratio (A) of low-HLB surfactant relative to water- | — | 1.00 | 0.25 | 2.50 | 2.50 | 1.25 |
| | soluble resin | | | | | | |
| Results | Evaluation of foreign substance at gas-liquid | | A | A | A | A | A |
| | interface | | | | | | |
| | Transfer evaluation (evaluation of belt resistance | | D | D | A | A | A |
| | value) | | | | | | |
| | Transfer evaluation (evaluation of contact angle) | | D | D | A | A | A |
| | Evaluation of ejection reliability (evaluation of | | A | A | D | D | D |
| | scattering) | | | | | | |
| | Evaluation of curling resistance | | B | B | B | B | B |
| | Evaluation of color development | | B | B | B | B | B |

| | | | Comparative Example | | | |
|---|---|---|---|---|---|---|
| Item | | | 6 | 7 | 8 | 9 |
| Ink | Coloring material | Pigment | 7.000% | 7.000% | 7.000% | 7.000% |
| composition | Dispersion resin | Dispersion resin 1 | 0.200% | | | |
| | | Dispersion resin 2 | | 0.200% | | |
| | Water-soluble | Water-soluble urethane resin 1 | | | | |
| | resin | Water-soluble urethane resin 2 | | | | |
| | | Water-soluble acrylic resin | | | | |
| | Inorgaanic oxide | Cataloid SI-45P | | | | |
| | particle | | | | | |
| | Acetylene glycol- | Olfine E1010 | 0.400% | 0.400% | 0.400% | 0.650% |
| | based surfactant | Surfynol 104PG50 | 0.250% | 0.250% | 0.250% | |
| | | Surfynol 420 | | | | |
| | Organic solvent | Glycerin | 10.00% | 10.00% | 10.00% | 10.00% |
| | | TEG | 3.000% | 3.000% | 3.200% | 3.200% |
| | | TEGmBE | 1.000% | 1.000% | 1.000% | 1.000% |
| | | TEGmME | 2.000% | 2.000% | 2.000% | 2.000% |
| | Water | — | 76.150% | 76.150% | 76.150% | 76.150% |

| | | | | | |
|---|---|---|---|---|---|
| Formula | Ratio (A) of low-HLB surfactant relative to water- | — | — | — | — |
| | soluble resin | | | | |
| Results | Evaluation of foreign substance at gas-liquid | C | C | A | A |
| | interface | | | | |
| | Transfer evaluation (evaluation of belt resistance | B | B | A | D |
| | value) | | | | |
| | Transfer evaluation (evaluation of contact angle) | B | B | A | D |
| | Evaluation of ejection reliability (evaluation of | B | A | D | B |
| | scattering) | | | | |
| | Evaluation of curling resistance | B | B | B | B |
| | Evaluation of color development | A | B | B | B |

The materials described in Tables 1 and 2 are as follows.

### Coloring Material

CAB-O-JET 300 (manufactured by Cabot Corporation, self-dispersing pigment, solid content: 15%)

### Dispersion Resin

Dispersion resin 1: “Vinyblan 2586” (manufactured by Shin-Etsu Chemical Co., Ltd., acrylic resin emulsion)
Dispersion resin 2: “Super Flex 420” (manufactured by DSK Co., Ltd., urethane-based resin emulsion)

### Water-Soluble Resin

Water-soluble urethane resin 1

The water-soluble urethane resin 1 was prepared by the following method.

First, a four-neck flask provided with a stirrer, a thermometer, a nitrogen gas inlet tube, and a reflux tube was prepared. In the four-neck flask, 41.7 parts by mass of isophorone diisocyanate, 40.1 parts by mass of polypropylene glycol (number-average molecular weight: 2,000), 13.2 parts by mass of dimethylol propionic acid, and 200.0 parts by mass of methyl ethyl ketone were added and reacted at 80° C. for 6 hours in a nitrogen gas atmosphere (primary reaction). Then, 0.6 parts by mass of ethylenediamine, 2.0 parts by mass of methanol, 2.4 parts by mass of dimethylol propionic acid, and 100.0 parts by mass of methyl ethyl ketone were added. The residual ratio of isocyanate groups was confirmed by FT-IR, and then reaction was performed at 80° C. until a desired residual ratio was obtained (secondary reaction), obtaining a reaction solution. After the resultant reaction solution was cooled to 40° C., ion exchange water was added, and an aqueous potassium hydroxide solution was added under high-speed stirring by a homomixer. Then, methyl ethyl ketone was distilled off from the resultant solution by heating under reduced pressure, producing a liquid containing the water-soluble urethane resin 1.

With respect to the resultant water-soluble urethane resin 1, the water-soluble urethane resin 1 was precipitated by adding hydrochloric acid to the liquid containing the water-soluble urethane resin 1 and then dried under vacuum at 40° C. overnight. The resultant resin was dissolved in tetrahydrofuran to prepare a sample. As a result of measurement of the acid value of the water-soluble urethane resin 1 by potentiometric titration using a potassium hydroxide-methanol titrant, the acid value was 65 mgKOH/g.

The number-average molecular weight is a value measured by gel permeation chromatography (GPC).

Also, with respect to the water-soluble urethane resin 1, the weigh-average molecular weight of the urethane resin in terms of polystyrene, measured by gel permeation chromatography (GPC), was 21000.
Water-soluble urethane resin 2

The water-soluble urethane resin 2 was prepared by the same preparation method as for the water-soluble urethane resin 1 except that in preparing the water-soluble urethane resin 1, the amount of the polypropylene glycol added was decreased, and the amounts of dimethylol propionic acid added in the primary reaction and secondary reaction were increased. As a result of measurement of the acid value and weight-average molecular weight by the same measurement methods as for the water-soluble urethane resin 1, the acid value of the water-soluble urethane resin 2 was 75 mgKOH/g, and the weight-average molecular weight was 21000.
Water-soluble acrylic resin

The water-soluble acrylic resin was prepared by the following method.

A four-neck flask provided with a stirrer, a thermometer, a reflux condenser, and a nitrogen gas inlet tube was prepared. In the four-neck flask, 200.0 parts by mass of ethylene glycol monobutyl ether was placed and heated to 130° C. under stirring in a nitrogen gas atmosphere. Then, 62.0 parts by mass of styrene monomer, 22.0 parts by mass of butyl acrylate, 16.0 parts by mass of acrylic acid, and 4.0 parts by mass of a polymerization initiator (tert-butyl peroxide) were dropped over 3 hours. After aging for 2 hours, ethylene glycol monobutyl ether was distilled off under reduced pressure, producing the water-soluble acrylic resin.

### Inorganic Oxide Particles

“Cataloid SI-45P” (manufactured by Nikki Shokubai Kasei Co., Ltd., silica particle-dispersed sol, average particle diameter: 45 nm)

### Acetylene Glycol-Based Surfactant

“Olfine E1010”: manufactured by Nissin Chemical Industry Co., Ltd.
“Surfynol 104PG50”: manufactured by Air Products Japan, Inc., 2,4,7,9-tetramethyl-5-decyne-4,7-diol
“Surfynol 420”: manufactured by Air Products Japan, Inc., alkylene oxide adduct of 2,4,7,9-tetramethyl-5-decyne-4,7-diol

### Organic Solvent

Glycerin
Triethylene glycol (denoted as “TEG” in the tables)
Triethylene glycol monobutyl ether (denotes as “TEGmBE” in the tables)
Triethylene glycol monomethyl ether (denotes as “TEGmME” in the tables)

### Water

Ion exchange water

A value calculated by a Griffin method was used as the HLB value of the acetylene glycol-based surfactant. Griffin method: HLB value=20×total formula weight of hydrophilic portion/molecular weight

In Tables 1 and 2, “low-HLB surfactant” in the expression “Ratio (A) of low-HLB surfactant relative to water-soluble resin” represents an acetylene glycol-based surfactant having a HLB value of 6 or less.

In addition, the “hydrophilic portion” is not particularly limited as long as it is a group having high affinity for water, and examples thereof include acid groups such as a carboxylate group, a sulfonate group, a phosphate group, a phosphonate group, a phosphonate group, and the like, and basic groups such as an amino group and the like.

### 2. Evaluation

### 2. 1. Evaluation of Foreign Substance at Gas-Liquid Interface

In a screw bottle of 50 mL, 30 g of the ink composition of each of the examples and comparative examples was placed and allowed to stand for 5 days in a constant temperature bath of 60° C. After allowed to stand, each of the ink compositions was returned to room temperature, and 10 mL was dropped on a filter having a diameter of 8 μm. Then, the foreign substance aggregated on the surface of the filter was observed.

### Evaluation Criteria

A: No foreign substance is present on the surface of the filter.
B: One or more and nine or less foreign substances are present on the surface of the filter.
C: Ten or more foreign substances are present on the surface of the filter.

### 2. 2. Evaluation of Transfer (Evaluation of Belt Resistance Value)

A modified machine of ink jet recording apparatus LX-10000F (manufactured by Seiko Epson Corporation) was filled with the ink composition of each of the examples and comparative examples, and printing was performed on both sides of 500 recording media Nautilus Classic (manufactured by Mondi Ltd.) in an environment of 10° C. and a relative humidity of 80% under the printing conditions of 600×1200 dpi, 6.7 ng/dot, and a dot density of 100%. After printing, a transport belt unit was taken out from the modified machine of LX-10000F, and the resistance value on the transport belt after printing was measured by using a resistivity meter (Hiresta UX MCP-HT800) according to JIS K6911.

### Evaluation Criteria

A: The resistance value of the transport belt is not decreased by printing, and the resistance value of the transport belt after printing is 1.0×10¹⁵[Ω] or more.
B: The resistance value of the transport belt is decreased by printing, and the resistance value of the transport belt after printing is 1.0×10¹⁴[Ω] or more and less than 1.0×10¹³[Ω].
C: The resistance value of the transport belt is decreased by printing, and the resistance value of the transport belt after printing is 1.0×10¹³[Ω] or more and less than 1.0×10¹⁴[Ω].
D: The resistance value of the transport belt is decreased by printing, and the resistance value of the transport belt after printing is less than 1.0×10¹³[Ω].

### 2. 3. Evaluation of Transfer (Evaluation of Contact Angle)

A modified machine of ink jet recording apparatus LX-10000F (manufactured by Seiko Epson Corporation) was filled with the ink composition of each of the examples and comparative examples, and 0.5 μL of ink droplets were dropped on recording medium Nautilus Classic (manufactured by Mondi Ltd.) in an environment of 10° C. and a relative humidity of 80% under the printing cnditions of 600×1200 dpi, 6.7 ng/dot, and a dot density of 100%. Then, the contact angle 2.6 seconds after landing was measured by portable contact angle meter PCA-1 (manufactured by Kyowa Interface Science Co., Ltd.).

### Evaluation Criteria

A: The contact angle is less than 15°.
B: The contact angle is 15° or more and less than 20°.
C: The contact angle is 20° or more and less than 25°.
D: The contact angle is 25° or more.

### 2. 4. Evaluation of Ejection Reliability (Evaluation of Scattering)

A modified machine of ink jet recording apparatus LX-10000F (manufactured by Seiko Epson Corporation) was filled with the ink composition of each of the examples and comparative examples, and a test pattern was recorded on recording medium superfine paper (manufactured by Seiko Epson Corporation) in an environment of 32° C. and a relative humidity of 20%. Then, an ink jet head was let idle in a state of being filled with the ink composition for 20 seconds in an environment of 32° C. and a relative humidity of 20%, and then a test pattern was recorded on recording medium Nautilus Classic (manufactured by Mondi Ltd.) under the same conditions as described above. A landing position deviation of the ink composition on the recording medium before and after idle running was measured by comparison between the resultant two test patterns and evaluated according to evaluation criteria below.

### Evaluation Criteria

A: The landing position deviation amount is 0 μm or more and less than 50 μm.
B: The landing position deviation amount is 50 μm or more and less than 100 μm.
C: The landing position deviation amount is 100 82 m or more and less than 200 μm.
D: The landing position deviation amount is 200 μm or more.

### 2.5. Evaluation of Curling Resistance

An ink jet recording apparatus PX-S840 manufactured by Seiko Epson Corporation was filled with the ink composition of each of the examples and comparative examples, and a solid pattern was printed on postcard size recording medium Xerox P (manufactured by Fuji Xerox Co., Ltd., basis weight: 64 g/m², paper thickness: 88 μm) with 600×1200 dpi, 13 ng/dot, dot density of 100% in an environment of 25° C. and a relative humidity of 50%. After printing, when the recording medium was allowed to stand face down, the angle between the installation point of the paper and the floor and the paper end was measured with time, and the maximum curling angle was determined.

### Evaluation Criteria

A: The maximum curling angle is less than 90°.
B: The maximum curling angle is 90° or more.

### 2. 6. Evaluation of Color Development

An ink jet recording apparatus PX-S840 manufactured by Seiko Epson Corporation was filled with the ink composition of each of the examples and comparative examples, and a solid pattern was printed on postcard size recording medium Xerox P (manufactured by Fuji Xerox Co., Ltd., basis weight: 64 g/m², paper thickness: 88 μm) with 600×1200 dpi, 6.7 ng/dot, dot density of 100% in an environment of 25° C. and a relative humidity of 50%. Then, the OD value (optical density) was measured by using i1Pro2 (manufactured by X-Rite Co., Ltd.).

### Evaluation Criteria

A: The OD value is 1.3 or more.
B: The OD value is 1.2 or more and less than 1.3.
C: The OD value is 1.1 or more and less than 1.2.
D: The OD value is less than 1.1.

### 3. Evaluation Results

The evaluation results shown in Tables 1 and 2 indicate that any one of Examples 1 to 12 is excellent in the evaluation of foreign substances at a gas-liquid interface, evaluation of transfer, and ejection reliability as compared with Comparative Example 1 in which the content A of the acetylene glycol-based surfactant is a predetermined ratio or less, Comparative Examples 2 to 4 in which the content of the acetylene glycol-based surfactant relative to the content of the water-soluble urethane resin is out of a predetermined range, Comparative Examples 5 to 7 using a resin other than the water-soluble urethane resin, Comparative Example 8 not using a resin, and Comparative Example 9 not using both a resin and a surfactant.

What is claimed is:

1. An aqueous ink jet ink composition comprising:
a coloring material;
a water-soluble urethane resin; and
an acetylene glycol-based surfactant having a HLB value of 6 or less, wherein
the content A of the acetylene glycol-based surfactant relative to the total mass of the ink jet ink composition is 0.1% by mass or more; and
the ratio (A/U) of the content A of the acetylene glycol-based surfactant to the content U of the water-soluble urethane resin is from 0.3 to 2.3.

2. The ink jet ink composition according to claim 1, wherein
the content U of the water-soluble urethane resin relative to the total mass of the ink jet ink composition is from 0.1% to 0.8% by mass.

3. The ink jet ink composition according to claim 1, wherein
the content A of the acetylene glycol-based surfactant relative to the total mass of the ink jet ink composition is from 0.1% to 0.8% by mass.

4. The ink jet ink composition according to claim 1, wherein
the water-soluble urethane resin contains a water-soluble urethane resin having an acid group.

5. The ink jet ink composition according to claim 1, wherein
the water-soluble urethane resin contains a water-soluble urethane resin having an acid value of from 40 to 90 mgKOH/g.

6. The ink jet ink composition according to claim 1, wherein
the coloring material contains any one of a self-dispersing pigment and a resin-dispersed pigment.

7. The ink jet ink composition according to claim 1, wherein
the content of a dispersion resin relative to the total mass of the ink jet ink composition is less than 0.2% by mass.

8. The ink jet ink composition according to claim 1, wherein
the acetylene glycol-based surfactant contains a compound represented by formula (1), 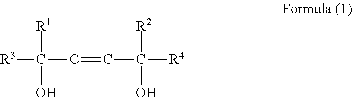
(R¹ to R 4 each independently represent an alkyl group having 1 to 4 carbon atoms).

9. The ink jet ink composition according to claim 1, further comprising inorganic oxide particles.

10. The ink jet ink composition according to claim 1, further comprising an organic solvent, wherein. p1 the organic solvent contains polyols having a standard boiling point of over 280° C.

11. The ink jet ink composition according to claim 1, wherein p1 the composition is used for recording on an absorptive recording medium.

12. A recording method comprising:
an ink adhesion step of ejecting and adhering the ink jet ink composition according to claim 1 from an ink jet head to a recording medium.

13. The recording method according to claim 12, further comprising:
a supply step of supplying the ink jet ink composition from an ink container to the ink jet head through an ink flow path, wherein
in the supply step, a gas-liquid interface occurs in the ink jet ink composition.
